(19) United States
(12) Patent Application Publication
(10) Pub. No.: US 2011/0175902 A1
(43) Pub. Date: Jul. 21, 2011

(54) MULTILAYER DISPLAY DEVICE

(75) Inventor: Peter H. Mahowald, Los Altos, CA (US)

(73) Assignee: Apple Inc., Cupertino, CA (US)

(21) Appl. No.: 12/690,660

(22) Filed: Jan. 20, 2010

(51) Int. Cl. G06T 15/00; G06F 15/16

(52) U.S. Cl. 345/419; 345/502

(57) ABSTRACT

A multilayer display system includes a first layer operable to display a first display signal comprising a first group of data, a second layer positioned in front of the first layer and operable to display a second display signal comprising a second group of data, and a first graphics processing unit connected to the first layer. The first graphics processing unit may be configured to transmit the first display signal to the first layer. The multilayer display system further includes a second graphics processing unit connected to the second layer. The second graphics processing unit may be configured to transmit the second display signal to the second layer.

### BACKGROUND

1. Technical Field

Embodiments generally relate to display devices, and more particularly, to a display device having multiple layers upon which data may be displayed.

2. Background Discussion

Many electronic components, devices and/or systems utilize two-dimensional display devices. Creating the illusion of a three-dimensional image on a two-dimensional display has been the subject of ongoing technological research and development, and is experiencing a worldwide resurgence due to recent developments in computer-generated imagery and high-definition video. Currently, the perception of depth of a three-dimensional image may be created by computer graphics that are used to enhance a displayed two-dimensional image, such as through shading or brightness effects, or by the creation of a stereoscopic image.

Many such techniques are imperfect. For example, adjusting the brightness or shading of an image may enhance the realism of a two-dimensional image, but can only enhance the perceived depth of a flat image to a limited extent. Further, most stereoscopic display devices often require that the viewer use an optical device, such as color-filter glasses or polarized glasses, to see a stereoscopic image in simulated three dimensions, and/or expensive projection equipment for generating and displaying the stereoscopic images. As such, most stereoscopic display devices are not practical for personal use.

### SUMMARY

Embodiments disclosed herein may include a display system that includes a multilayer display device. The multilayer display system may include a first layer operable to display a first display signal comprising a first group of data, a second layer positioned in front of the first layer and operable to display a second display signal comprising a second group of data. The display system may also include a first graphics processing unit connected to the first layer. The first graphics processing unit may be configured to transmit the first display signal to the first layer. The display system may further include a second graphics processing unit connected to the second layer. The second graphics processing unit may be configured to transmit the second display signal to the second layer.

In another embodiment, the second layer may be a transparent OLED display device. In a further embodiment, the display system may further include at least one processor configured to display the first and second groups of data on the second layer and turn off the first layer. In an additional embodiment, the system may further include a battery configured to supply power to the first and second layers, and the at least one processor may be configured to turn off the first layer based on a battery level of the battery. In an additional embodiment, at least one processor may be configured to determine whether a third group of display data can be processed to obtain separate display signals.

In some embodiments, if the at least one processor determines that the third group of data cannot be processed to obtain separate display signals, the third group of data may be displayed on the second layer. In another embodiment, the system may further include a third layer operable to display a third display signal and positioned behind the first layer. In one embodiment, the first layer and the second layer may be separated by a first distance, and the first layer and the third layer may be separated by a second distance. The first distance may be different from the second distance.

Embodiments disclosed herein may also include a method for displaying a three-dimensional image. The method may include receiving a computer program, separating a set of graphical elements of the computer program into a first data set and a second data set based on a characteristic of the computer program, processing the first data set to obtain a first display signal corresponding to the first data set and a second display signal corresponding to the second data set, and transmitting the first display signal to a first layer of a multilayer display system and the second display signal to a second layer of the multilayer display system. The first layer may overlay the second layer.

In another embodiment the computer program may comprise an application running on an operating system. Furthermore, the characteristic may include whether the application is active or inactive. Another embodiment may include displaying the application on the first display layer if the application is active and displaying the application on the second layer if the application is inactive.

In another embodiment, the characteristic may include whether the application is a window or a menu bar. In a further embodiment, the method may further include displaying the application on the first display layer if the application is a menu bar. In another embodiment, the method may include separating the computer program into a third data set based on a characteristic of the computer program, processing the third data set to obtain a third display signal corresponding to the third data set, and transmitting the third display signal to a third layer positioned behind the first and second layers.

Embodiments disclosed herein may further include a display system. The display system may include a memory device storing an operating system running a first application and a second application. The display system may further include at least one processor connected to the memory device and configured to separate the first and second applications into a first data set corresponding to the first application and a second data set corresponding to the second application based on a characteristic of the first and second applications and process the first and second data sets to obtain a first display signal and a second display signal. The display system may also include a first display layer connected to the memory device and configured to display the first display signal, and a second display layer connected to the memory device and configured to display the second display signal.

### BRIEF DESCRIPTION OF THE DRAWINGS

FIG. 1A is a front view of an embodiment of a display device.

FIG. 1B is a partial exploded view of the embodiment shown in FIG. 1A.

FIG. 1C is a schematic exploded cross sectional view of the embodiment shown in FIG. 1A taken along line C-C.

FIG. 2 depicts a first embodiment of a three-dimensional display system.

FIG. 3 depicts a second embodiment of a three-dimensional display system.

FIG. 4 depicts an embodiment of an operating system, as displayed on the display panels of the display device illustrated in FIGS. 1A-1C.

FIG. 5 is a flowchart depicting a method for displaying an image on a multilayer display device.

### DETAILED DESCRIPTION OF EMBODIMENTS

Generally, one embodiment may take the form of a multilayer display device, where each layer is made of a separate element. Each display element may be referred to herein as a “layer” or a “panel,” although any given display element may take any form and may be constructed from any of a variety of materials. For example, a panel may be a relatively thin sheet of organic light-emitting diode (OLED) material, in some embodiments transparent, or a more conventional liquid crystal display with or without backlighting (such as CCFL or light-emitting diode (LED) backlighting), a LED display, e-ink, and so forth. Accordingly, the terms “layer” and “panel” are used for convenience and should not be read as a limitation on the structure or implementation of any display element.

The panels may be separated by one or more distances or may have varying thicknesses to create the perception of depth to a viewer looking at the display device from a front perspective. Some or all of the panels may be OLED displays, some or all may be transparent. For example, all of the panels may be transparent except for the one farthest from the observer, which may be an opaque LCD display. As will be further discussed below, the display device may be part of a system that is configured to display data, graphics, software, and/or an operating system across multiple panels of the display device. For example, the system may be configured to separate the various components of a graphical user interface of the operating system so that certain applications or images may be displayed on different panels.

It should be noted that embodiments may be used in a variety of computing and/or display systems. Embodiments may include, be incorporated in, or work with a variety of display components, monitors, screens, images, indicators, computing elements (including input/output devices) and other electrical devices, including portable media players, personal digital assistant devices, laptops, desktop computers, and electronic gaming devices as well as automobiles and medical devices. Aspects of the embodiments described herein may be used with practically any apparatus related to optical and electrical devices, display devices, presentation systems or any apparatus that may contain any type of display system. Accordingly, embodiments may be employed in computing systems and devices used in visual presentations and peripherals and so on.

Before explaining the disclosed embodiments in detail, it should be understood that the embodiments herein are not limited in its application to the details discussed or particular arrangements shown, because the embodiments are capable of other embodiments. Also, the terminology used herein is for the purpose of description and not of limitation.

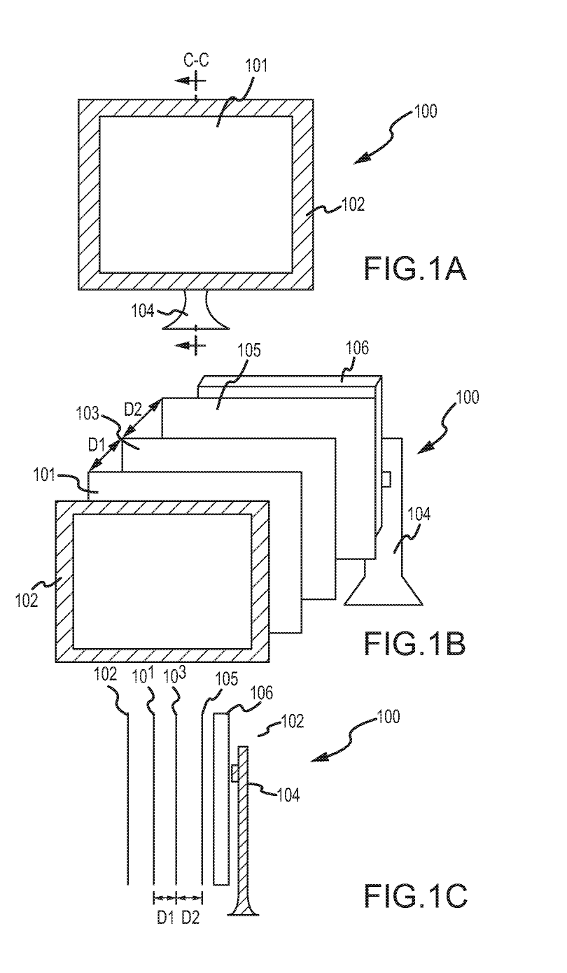

FIGS. 1A-1C illustrate one embodiment of a layered display device 100 capable of displaying data in three dimensions. The display device 100 may include front and middle display panels 101, 103 positioned in front of a rear display panel 105. The front and middle panels 101, 103 may be organic light emitting diode (“OLED”) display devices. The rear display panel 105 may be any known display device, including a liquid crystal display (“LCD”), a plasma display panel, an electroluminescent display, a light emitting diode (“LED”) display, an opaque or transparent OLED display device, and so on.

In some embodiments, the display device 100 may further include a bezel 102 configured to frame the layered display device 100, a rear frame 106, as well as a stand 104 configured to support the display device 100. As is well known in the art, the stand 104 and the rear frame 106 may be adjustably attached so that a user may adjust the height of the display device. It should be appreciated that this is merely one example of a support for the display device 100, and that other configurations may exist. For example, if all of the display panels 101, 103, 105 are transparent display devices, the rear frame 106 and stand 104 may have different configurations, or may be omitted from the display device 100 altogether, so that a viewer viewing the display device 100 from the front does not see the frame 106 or stand 104 behind the panels 101, 103, 105. Similarly, the bezel 102 may be omitted or may not frame the entire display device 100. For example, the bezel 102 may only cover one edge of the display panels 101, 103, 105.

In one embodiment, the front and middle panels 101, 103 may be transparent OLED display devices that are top emitting, bottom emitting, or both top and bottom emitting. In other embodiments, the front and middle panels 101, 103 may be any transparent display device, including a transparent LCD device, or any other transparent or opaque display device. Generally, an OLED is an LED having an emissive electroluminescent layer made from an organic compound, typically a film. The organic compound film may be deposited in rows and columns onto a carrier layer and a result in a matrix of subpixels emitting different color lights; such subpixels may be stacked on one another or adjacent. OLEDs are also known as light emitting polymers or organic electroluminescent devices.

The use of OLED panels may provide an advantage over traditional display devices, since OLED panels do not require a backlight to function, and may therefore be much thinner and lighter than backlit display panels. OLED panels are further capable of displaying deep black levels and can naturally achieve a high contrast ratio. Additionally, OLED panels draw a relatively small amount of power for the light produced, and therefore require less power for their operation than many backlit display devices. OLEDs may be used in a number of devices, including displays, lights, indicators, decorations, mobile devices, personal digital assistants, and so on and so forth.

FIG. 1A illustrates a front view of the display device 100. As shown, the front, middle and rear display panels 101, 103 and 105 may be aligned in a parallel configuration so that a viewer viewing the display device 100 from the front may only see a single panel. In one embodiment, as shown in FIGS. 1B and 1C, the panels 101, 103 and 105 may be spaced apart by a preset distance D1, D2, such as between approximately 1-2 mm, to create the perception of depth for a viewer viewing the display device 100. (FIG. 1B is a partial exploded view of the display device 100 while FIG. 1C is a cross-sectional view taken along line C-C of FIG. 1A.) In particular, the distance D1, D2 between the display panels 101, 103 and 105 may provide a depth effect so that the human eye may discern that images displayed on the rear panel 105 are at a further distance from the viewer than images displayed on the front and middle panels 101, 103. The distance D1, D2 between the display panels 101, 103, 105 may be uniform, or, in other embodiments, the front and middle panels 101, 103 may be separated by a larger or small distance than the middle and rear panels 103 and 105, depending on the desired depth effect. For example, spacing the panels a larger distance apart may cause images displayed on the back panel to appear further away, thereby increasing the depth effect, while spacing the panels a shorter distance apart may cause images displayed on the back panel to appear closer, thereby lessening the depth effect.

In other embodiments, the perception of depth, or actual depth, may created by using thicker display panels, rather than varying the spacing between the panels. For example, the depth effect may be increased or decreased by using thicker or thinner panels. In one embodiment, the front and middle display panels 101, 103 may be OLEDs that are attached to a transparent substrate layer having a desired thickness and positioned either in front of or behind the corresponding OLED, thereby increasing the perceived depth of the images displayed on the panels. The thickness of the panels of the display device may vary. For example, the front panel may be thicker or thinner than the middle and/or rear panels. Other embodiments may vary perceived or actual depth through a combination of panel spacing and panel thickness.

As discussed above, the front and middle panels 101, 103 may be transparent OLED panels. As such, the pixels of the OLED panels may remain transparent (or partially transparent) when an OLED panel is in use. In one embodiment, the transparent portions of the front panel 101 may allow a viewer to see images displayed on the middle 103 and rear panels 105, while the transparent portions of the middle 103 panel may allow a viewer to see images displayed on the rear panel 105. In another embodiment, light emitted from overlapping pixels of the front and middle panels 101, 103 may be combined to produce a light having an increased illumination when compared to the light emitted by either one of the two panels 101, 103 individually. In a further embodiment, light emitted from overlapping pixels may be combined to result in different tints or shades of emitted colored light. The same effects can be achieved with respect to the front and/or middle panels 101, 103 and the rear panel 105.

Certain OLED panels are partially transparent as opposed to fully transparent. Embodiments employing such partially transparent OLED panels may increase the brightness and/or intensity of graphics and/or other data displayed on the middle and back screens to account for the partial opacity and possible light-filter effects of the front and middle panels. In such embodiments, the brightness and/or color intensity of graphics displayed on the middle panel may be enhanced or increased by a percentage or amount to appear, to a user, to have the same optical qualities as graphics displayed on the front panel. Likewise, graphics on a rear panel may be even further enhanced than those on a middle panel. Thus, the graphical enhancement may at least partially offset or overcome the filtering effects of the semi-transparent OLED panels in front of the panel displaying the enhanced graphic.

Although the display device 100 illustrated in FIGS. 1A-1C has only three panels 101, 103, 105, it should be understood that embodiments may employ more or fewer display panels. Further, the system shown in FIGS. 1A-1C employs two OLED or three OLED display panels, however, certain embodiments may use more or fewer OLED display panels.

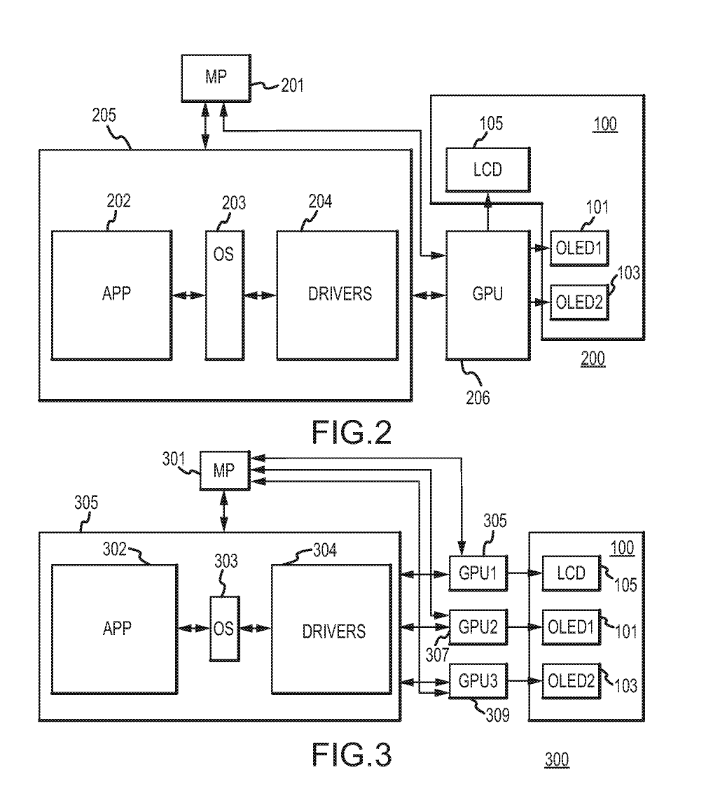

FIGS. 2 and 3 illustrate first and second embodiments of systems 200, 300 for implementing the display device 100 shown in FIG. 1. Referring initially to FIG. 2, one system 200 may include a microprocessor 201 and a memory device 205 running various computer programs, including application software 202, an operating system 203, and a device driver 204. The system 200 may further include a graphics processing unit 206 (“GPU”) that may be connected to the memory device 205 and to each display panel 101, 103, 105 of the display device 100.

Depending on the desired configuration, the microprocessor 201 can be any type of processor including a single- or multi-chip CPU or system-on-a-chip, and may have any design, including, but not limited to an 8-bit, 16-bit, 32-bit, 64-bit, or multicore design. The microprocessor 201 may be connected to the memory device 205 and to the graphics processing unit 206. By way of example and not limitation, the connections between the microprocessor 201 and the memory device 205 may be any connection, including a wired or wireless connection, a bus connection, a network, and so on and so forth.

The memory device 205 may include any suitable form of memory including, but not limited to, e.g., volatile memory such as random access memory (RAM), non-volatile memory such as read only memory (ROM) or flash memory storage, data storage devices such as magnetic disk storage (e.g., hard disk drive or HDD), tape storage, optical storage (e.g., compact disk or CD, digital versatile disk or DVD), or other machine-readable storage mediums and/or computer-accessible mediums that may be removable, non-removable, volatile or non-volatile, or combinations of any of the foregoing. For example, the memory 205 may include both magnetic disk storage and RAM. Further, elements of the memory device 205 may operate separately and independently of one another. As discussed above, the memory device 205 may be configured to store various computer programs and provide them to the processor 201 for execution, such as application software 202 and system software, such as an operating system 203, and device drivers 204.

The application software 202 may be configured to accomplish certain computer-executable tasks including, but not limited to, word processing capabilities, spreadsheets, media players, database applications, and so on. The operating system 203 may serve as a host for the application software 202 invoked by the user as well as providing general interfaces between the hardware of the system and a user. The operating system may also manage and coordinate resources of the computing system, both hardware and software. In one embodiment, the operating system 203 may use an application programming interface (“API”) to enable interaction between application software programs 202. As is well known in the art, the application software 202 and operating system may include displayed content and the user may interact with the operating system 203 and application software 202 through a software user interface, such as a command line interface or a graphical user interface (“GUI”).

The operating system 203 may be programmed to separate certain constituent graphical elements of itself and/or the application software 202 with respect to the panels 101, 103, 105 in the display device 100. That is, the operating system (or a specialized driver) may break a two-dimensional display into separate elements and assign each such element to a layer of the display device. As one example, these graphical elements may be various features of the GUI of the operating system 203 and/or application software 203. Continuing the example, the operating system 203 may be configured to group certain applications and/or images into separate data sets, with one data set corresponding to each panel 101, 103, 105 in the display device 100. The applications may be grouped by the status of an application, for example, whether an application is active, inactive, open, closed, and so on and so forth. The applications may also be grouped by application type, for example, whether the application is a window, an onscreen button or icon, a menu, a menu bar, and so on. As an example, with respect to the display device 100 shown in FIGS. 1A-1C, the programming of the application software 202 and/or operating system 203 may separate the graphical elements of the applications into three data sets, with one data set corresponding to each panel 101, 103, 105.

The application software 202 and/or operating system 203 may interact with the display device 100 using a device driver 204 stored in the memory device 205. For example, a program in the application software 202 may invoke a routine in the driver 204, and the driver 204 may issue commands to the display device 100 through the GPU 206. Additionally, the display device 100 may transmit data back to the driver 204 via the GPU 206, and the driver 204 may invoke routines in the calling program.

The GPU 206 may offload some of the graphics processing required for generating images from the microprocessor 201 by generating and transmitting display signals to the display device 100. In particular, the GPU 206, either alone or in combination with the microprocessor 201, may process data to generate separate display signals for transmission to and display on a corresponding panel 101, 103, 105. The GPU 206 may be attached to a video card, or alternatively, may be an integrated GPU that is attached to the motherboard. In other embodiments, the operating system 203 and/or application software 202 may be configured to separate the applications into more or fewer display signals, for example, if a display device includes more or fewer panels and/or if some of the panels of the display device are not used.

As shown in FIG. 2, a single GPU 206 may be connected to each panel 101, 103, 105 of the display device 100 for rendering separate images on each panel 101, 103, 105. The images may be two-dimensional, three-dimensional and/or high-definition images. The GPU 206 may be connected to the display device 100 via any known connector, including, but not limited to, HDMI, VGA, DVI, and/or DisplayPort connectors. Thus, with respect to the example system 200 shown in FIG. 2, the GPU 206 may be configured to generate three different display correlating to images to be displayed on each of the three panels 101, 103, 105.

The GPU 206 may be further configured to power on or power off the individual panels 101, 103, 105. In such an embodiment, the GPU 206 may cease providing power to one or more of the panels 101, 103, 105 when a power-off command is received from the microprocessor 201, for example, through the operating system 203. In one embodiment, the GPU 206 may be configured to turn off all of the panels with the exception of the foremost panel 101 and combine the display signal intended for the rear panels 103, 105 with the display signal intended for the foremost panel 101 for display on the foremost panel 101. As such, in this embodiment, all of the displayed content is displayed only on the foremost panel 101. This embodiment may generate power savings, insofar as power is no longer required for utilizing the middle 103 and rear 105 panels, and may be useful in portable devices during a low battery situation. It should be appreciated that any of the various layers of the display may be used as the single panel displaying information.

FIG. 3 illustrates an alternative embodiment of a system 300 for implementing the display screen system 100 shown in FIG. 1. Referring to FIG. 3, the system 300 may include a microprocessor 301 and a memory device 305 running application software 302, an operating system 303, and a device driver 304. The functions of the microprocessor 301, memory device 305, application software 302, operating system 303, and device driver 304 may be similar or identical to that discussed above with respect to the same components in the system 200 illustrated in FIG. 2.

Referring to FIG. 3, the memory device 305 may be connected to multiple GPUs 306, 307, 309, and the system 300 may include multiple graphics processing units 306, 307, 309 that are each connected to a display panel 101, 103, 105 in the display device 100. Since each panel 101, 103, 105 is designated to a respective GPU 306, 307, 309, the processing of each GPU 306, 307, 309 is limited to a single display panel 101, 103, 105. As such, this embodiment may be may require less graphics processing associated with each GPU 306, 307, 309 than the embodiment shown in FIG. 2, but may require more processing by the microprocessor 301, for example, to separate the image data into distinct display signals and transmitting the display signals to the corresponding GPUs 306, 307, 309.

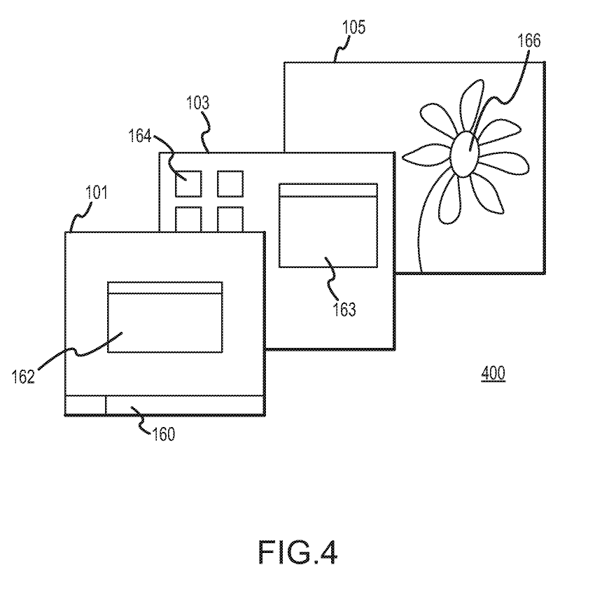

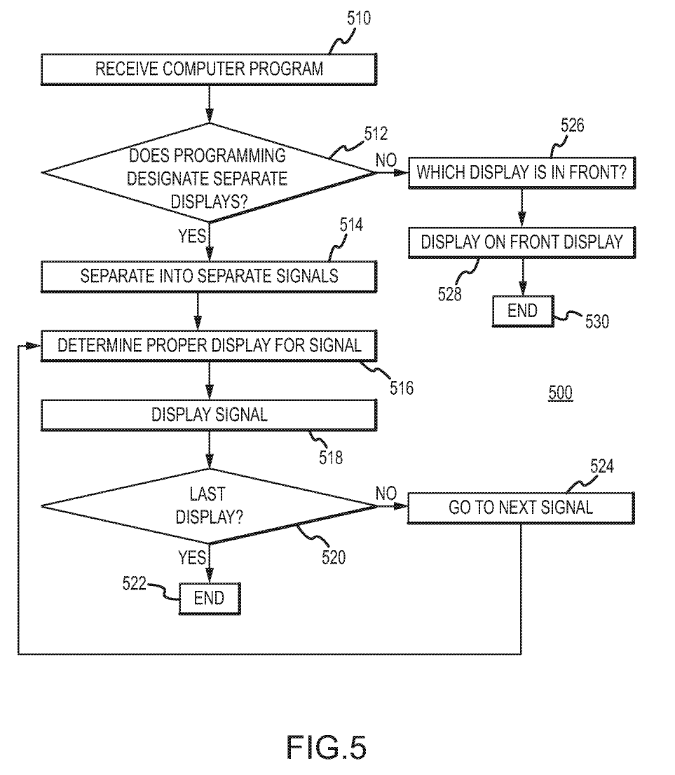

FIG. 4 illustrates a sample operating system 400, as well as certain applications and graphics 166, being shown on the display device 100 of FIGS. 1A-1C. As illustrated in FIG. 4, the operating system 400, applications, and other data for display may include a menu bar 160, e.g., for housing application-specific menus that provide access to applications, active and inactive applications that have been opened by the user 162, 163, desktop icons 164, e.g., representing files, folders and/or applications, and a background image 166.

In one embodiment, the front panel 101 may be configured to display the menu bar 160 as well as any active applications 162, e.g., open applications that are currently being in use. The middle panel 103 may be configured to display any inactive applications 163, i.e., open applications that are running on the operating system 400, but not currently in use, as well as any desktop icons 164 that are present on the user's desktop. Finally, the rear panel 105 may be configured to display the background image 166. It should be appreciated that this is merely one example of how to split display data between panels of the display device 100, and other examples may exist. In certain embodiments, a user may specify which graphics, text and/or other data is shown on each panel or layer of the display.

As yet another example, the front panel 101 may be configured to display the most recently selected application as the user switches from one open application to another, and the middle panel 103 may be configured to display other open applications. Thus, with respect to the embodiment shown in FIG. 4, if the user switches from application 163 to application 162, the front panel 101 may be updated to display the active application 162, and the middle panel 103 may be updated to display the inactive application 163. Continuing with this example, if the user selects one of the desktop icons 164 to open a third application, the front panel 101 may be updated to display the third application and the middle panel 103 may be updated to display the inactive applications 163 and 162.

In certain embodiments, the brightness of the front panel 101 and the middle panel 103 may be adjusted so as to emphasize images displayed by the front panel 101. For example, the middle panel 103 may be configured to display images at a lower brightness level so that images displayed on the front panel 101, for example, active applications 162 and the menu bar 160, appear brighter to the user.

As discussed above, the rear panel 105 may be configured to display a background image 166. The background image 166 may be a graphic that is the same size as the resolution of the rear panel 105, or, in other embodiments, may be smaller or larger than the resolution of the rear panel 105. The background image 166 may be an unmoving PNG or JPEG image, or, in other embodiments, may include a video clip or animation. In one embodiment, the brightness of the rear panel 105 may be lower than the brightness of the middle panel 103 and/or front panel 105. In another embodiment, the rear panel 105 may be brighter or dimmer than either the middle panel 103 and/or front panel 105.

In certain embodiments, the background image may be split into separate elements and displayed across the various panels of the display 400. For example, if the background image shows a tree and a bird in flight, the bird and tree may be defined as separate elements by the embodiment, as discussed above. The bird may then be displayed on the front or middle panel while the tree is shown on the rear panel. In this manner, three dimensionality of the background image may likewise be achieved or simulated. It should be noted that any graphic may be separated and displayed in such a fashion. By placing certain portions of a graphic on a panel nearer the user than other portions, aspects of the graphic may be emphasized to a user.

In other embodiments, the programs and applications of the operating system 400, including menu bar 160, open applications 162, 163, desktop icons 164, and/or the background image 166, may be displayed on different panels 101, 103, 105 than as described above. For example, the desktop icons 164 and/or any inactive applications 163 that are open but not currently being used may be displayed on the rear panel 105 with the background image 166. Additionally, the menu bar 160 may be displayed on the middle panel 103 or on the rear panel 105. In further embodiments, the operating system may be displayed on a display device including more or fewer panels and/or may not use all of the panels of the display device.

The operating system may further include additional content, such as shading effects, that may be displayed on one of the panel layers, either alone, or in conjunction with other content. The presentation of the menu bar 160, open applications 162, 163, desktop icons 164, and/or the background image 166 displayed by the panels 101, 103, 105 can also be configured to emphasize desired aesthetic effects, such as to give a mirrored, translucent, and/or shadowed appearance by adjusting the brightness of the panels displaying these elements, or by layering the panels to create a particular effect.

FIG. 5 is a flowchart generally describing one method 500 for displaying an image on a multilayer display device. In operation 510, a processor may receive a computer program. The computer program may represent system software, such as an operating system, or application software, such as an application, or some other program that can be run on an operating system, and may include display data representing the image. The processor may be a microprocessor and/or a graphics processing unit, or any other suitable computer processing unit. As discussed above, the image may be a three-dimensional image that is displayed on a multilayer display device that includes multiple display panels separated by a predetermined distance. In operation 512, the processor may determine whether the computer program is configured for display on multiple display panels. For example, the programming of the computer program may be configured to group the applications into multiple data sets that are processed by the GPU and/or microprocessor and converted into multiple display signals.

If, in operation 512, the processor determines that the computer program is configured for display on multiple display panels, then in operation 514, the processor may execute the computer program and separate the data sets with respect to the display panels. As discussed above, this may be done by the microprocessor, in conjunction with one or more GPUs. For example, the microprocessor may transmit a multiple signals to multiple GPUs, with each GPU corresponding to a single panel, or alternatively, the microprocessor may transmit a single signal to a single GPU that is configured to separate the signal into multiple display signals corresponding to the different panels.

In operation 516, the processor may determine the display panel that is associated with the display signal. In one embodiment, this may be performed by one or more GPUs that are connected to the panels. The display signals may include an identifier or a flag, for example, in the form of a header, indicating the corresponding panel associated with the display signal. In operation 518, display signal may be transmitted to the proper display panel for display. For example, if the header of the display signal designates the rear panel, then the display signal will be transmitted to the GPU, which may process the display signal and transmit the signal to the rear panel for display.

In operation 520, the processor may determine whether the display signal designates the last display panel in the display system. For example, the processor may determine whether the computer program includes any further data sets designating a display not already displaying content. If, in operation 520, the processor determines that there are no further data sets designating panels in the display system, then, in operation 522, the method will proceed to end state 522. If, however, in operation 520, the processor determines that the computer program includes further data sets designating other panels in the display system, then, in operation 524, the processor will increment the signal being operated upon and return the method to operation 516.

Alternatively, if in operation 512 the processor determines that the computer program is not configured for display on multiple display panels, then in operation 526, the processor may determine which display panel is in the front of the display system. This may be done by one or more GPUs, which may be connected to the individual display panels, in conjunction with the microprocessor. After determining which panel is positioned in the front of the display system, then, in operation 528, the display signal may be displayed on the front panel. In some embodiments, if the processor determines that the computer program is not configured for display on multiple display panels, then the processor may turn off the rear panels or decrease the power supplied to the rear panels (i.e., placing the panels in a standby or hibernation mode). In operation 530, the method will proceed to end state. It should be appreciated that that in other embodiments, the display signal need not be displayed on the front display panel, but may be displayed on any of the display panels of the display system, including the rear panel.

Although certain embodiments have been described with respect to particular apparatuses, configurations, components, systems and methods of operation, it will be appreciated by those of ordinary skill in the art upon reading this disclosure that certain changes or modifications to the embodiments and/or their operations, as described herein, may be made without departing from the spirit or scope of the disclosure. Accordingly, the proper scope of the embodiments are defined by the appended claims. The various embodiments, operations, components and configurations disclosed herein are generally exemplary rather than limiting in scope.

What is claimed is:

1. A multilayer display system, comprising:
a first layer operable to display a first display signal comprising a first group of data;
a second layer positioned in front of the first layer and operable to display a second display signal comprising a second group of data;
a first graphics processing unit connected to the first layer, the first graphics processing unit configured to transmit the first display signal to the first layer; and
a second graphics processing unit connected to the second layer, the second graphics processing unit configured to transmit the second display signal to the second layer.

2. The multilayer display system of claim 1, wherein the second layer is a transparent OLED display device.

3. The multilayer display system of claim 1, further comprising at least one processor configured to display the first and second groups of data on the second layer and turn off the first layer.

4. The multilayer display system of claim 3, further comprising a battery configured to supply power to the first and second layers, wherein the at least one processor is configured to turn off the first layer based on a battery level of the battery.

5. The multilayer display system of claim 1, further comprising at least one processor configured to determine whether a third group of display data can be processed to obtain separate display signals.

6. The multilayer display system of claim 5, wherein, if the at least one processor determines that the third group of data cannot be processed to obtain separate display signals, the third group of data is displayed on the second layer.

7. The multilayer display system of claim 1, further comprising a third layer operable to display a third display signal, the third layer positioned behind the first layer, wherein the first layer and the second layer are separated by a first distance and the first layer and the third layer are separated by a second distance, and the first distance is different from the second distance.

8. A method for displaying a three-dimensional image, comprising:
receiving a computer program;
separating a set of graphical elements of the computer program into a first data set and a second data set based on a characteristic of the computer program;
processing the first data set to obtain a first display signal corresponding to the first data set and a second display signal corresponding to the second data set; and
transmitting the first display signal to a first layer of a multilayer display system and the second display signal to a second layer of the multilayer display system, the first layer overlaying the second layer.

9. The method of claim 8, wherein the first layer is a transparent OLED device.

10. The method of claim 9, wherein the computer program comprises an application running on an operating system.

11. The method of claim 10, wherein the characteristic includes whether the application is active or inactive.

12. The method of claim 11, further comprising displaying the application on the first layer if the application is active and displaying the application on the second layer if the application is inactive.

13. The method of claim 10, wherein the characteristic includes whether the application is a window or a menu bar.

14. The method of claim 13, further comprising displaying the application on the first layer if the application is a menu bar.

15. The method of claim 8, further comprising separating the computer program into a third data set based on a characteristic of the computer program;
processing the third data set to obtain a third display signal corresponding to the third data set; and
transmitting the third display signal to a third layer positioned behind the first and second layers.

16. A display system, comprising:
a memory device storing an operating system running a first application and a second application;
at least one processor connected to the memory device and configured to separate the first and second applications into a first data set corresponding to the first application and a second data set corresponding to the second application based on a characteristic of the first and second applications and process the first and second data sets to obtain a first display signal and a second display signal;
a first display layer connected to the memory device and configured to display the first display signal; and
a second display layer connected to the memory device and configured to display the second display signal.

17. The display system of claim 16, wherein the first display layer is positioned in front of the second display layer.

18. The display system of claim 16, wherein the first display layer is configured to display the first display signal at a higher brightness level than the second display layer displays the second display signal.

19. The display system of claim 16, wherein the first application is an active application and the second application is an inactive application.

20. The display system of claim 16, wherein the at least one processor is further configured to combine the first and second display signals and transmit the combined display signals to the first layer.
